(19) United States
(12) Patent Application Publication
(10) Pub. No.: US 2018/0232498 A1
(43) Pub. Date: Aug. 16, 2018

(54) PROVIDING STIMULI TO REGULATE EATING HABITS

(71) Applicant: AT&T Intellectual Property I, L.P., Atlanta, GA (US)

(72) Inventors: Greg W. Edwards, Austin, TX (US); James H. Pratt, Round Rock, TX (US)

(21) Appl. No.: 15/433,231

(22) Filed: Feb. 15, 2017

(51) Int. Cl. G06F 19/00

(52) U.S. Cl. CPC G06F 19/3475

(57) ABSTRACT

In one example, the present disclosure describes a device, computer-readable medium, and method for regulating a user's eating habits. For instance, in one example, a food-related event is detected in the user's vicinity. A response to the food-related event is determined in accordance with a preference of the user. A feedback action is then initiated to evoke a user reaction to the food-related event that is consistent with the response.

The present disclosure relates generally to automated assistance, and relates more particularly to devices, non-transitory computer-readable media, and methods for providing stimuli to regulate a user's eating habits.

### BACKGROUND

People are paying greater attention to what they eat. Some people may be motivated to change their eating habits in order to lose weight or improve athletic performance. Others may be motivated by a desire to manage other aspects of their health that are connected to their eating habits (e.g., to lower blood pressure, control diabetes symptoms, avoid allergens, etc.).

### SUMMARY

In one example, the present disclosure describes a device, computer-readable medium, and method for regulating a user's eating habits. For instance, in one example, a food-related event is detected in the user's vicinity. A response to the food-related event is determined in accordance with a preference of the user. A feedback action is then initiated to evoke a user reaction to the food-related event that is consistent with the response.

In another example, a device includes a processor and a computer-readable medium storing instructions which, when executed by the processor, cause the processor to perform operations. The operations include detecting a food-related event in a vicinity of a user, determining a response to the food-related event in accordance with a preference of the user, and initiating a feedback action to evoke a user reaction to the food-related event that is consistent with the response.

In another example, an apparatus includes a sensor, a processor, and an output device. The sensor detects a food-related event in a vicinity of a user. The processor determines a response to the food-related event in accordance with a preference of the user. The output device initiates a feedback action to evoke a user reaction to the food-related event that is consistent with the response.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of a first example method for regulating a user's eating habits in accordance with the present disclosure;

FIG. 3 illustrates a flowchart of a second example method for regulating a user's eating habits in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides stimuli to regulate eating habits. As discussed above, people are paying greater attention to what they eat. However, this does not mean that it is always easy to make the best eating choices. Poor eating habits can still develop consciously or unconsciously.

Examples of the present disclosure leverage the availability and versatility of mobile communications devices to monitor a user's eating habits and to provide stimuli, when appropriate, to help the user improve those eating habits. The stimuli may be in the form of an audible or visible alert (e.g., a text message or application-based alert sent to the user's smartphone), or in the form of some sort of tactile feedback to a wearable smart device (e.g., a buzzing or pinching sensation initiated by a smart watch or a wearable fitness tracker). In yet another example, the stimuli may be in the form of a non-invasive signal or stimulus that is sent to the user's brain using a wearable smart device (e.g., using transcranial magnetic stimulation or transcranial direct current stimulation to induce a certain mood).

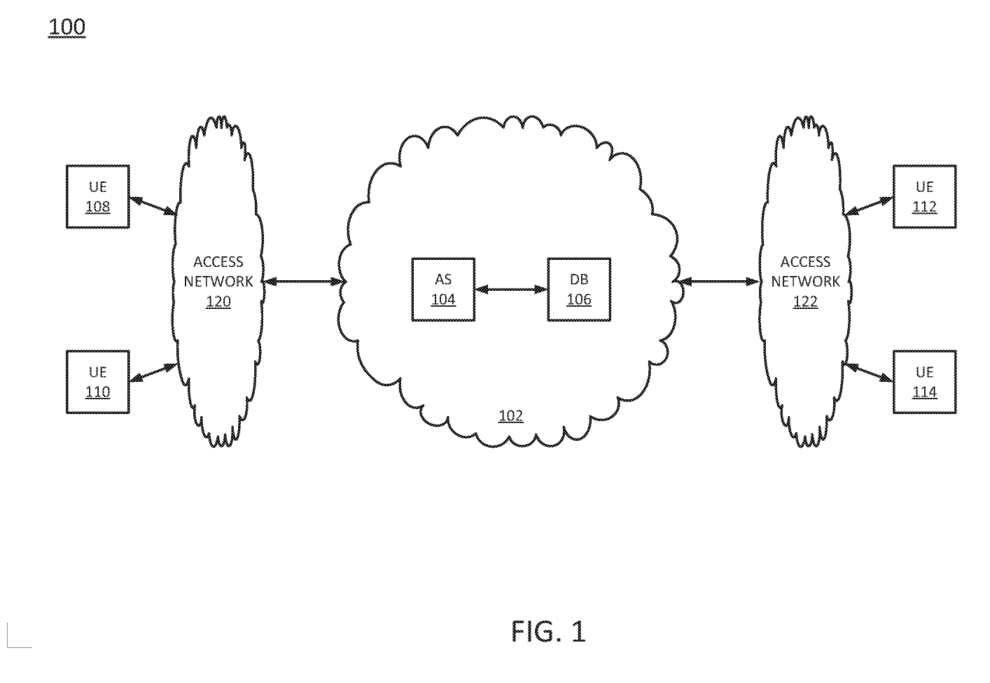

To better understand the present disclosure, FIG. 1 illustrates an example network 100, related to the present disclosure. The network 100 may be any type of communications network, such as for example, a traditional circuit switched network (CS) (e.g., a public switched telephone network (PSTN)) or an Internet Protocol (IP) network (e.g., an IP Multimedia Subsystem (IMS) network, an asynchronous transfer mode (ATM) network, a wireless network, a cellular network (e.g., 2G, 3G and the like), a long term evolution (LTE) network, and the like) related to the current disclosure. It should be noted that an IP network is broadly defined as a network that uses Internet Protocol to exchange data packets. Additional exemplary IP networks include Voice over IP (VoIP) networks, Service over IP (SoIP) networks, and the like.

In one embodiment, the network 100 may comprise a core network 102. In one example, core network 102 may combine core network components of a cellular network with components of a triple play service network; where triple play services include telephone services, Internet services, and television services to subscribers. For example, core network 102 may functionally comprise a fixed mobile convergence (FMC) network, e.g., an IP Multimedia Subsystem (IMS) network. In addition, core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may also further comprise an Internet Service Provider (ISP) network. In one embodiment, the core network 102 may include an application server (AS) 104 and a database (DB) 106. Although only a single AS 104 and a single DB 106 are illustrated, it should be noted that any number of application servers 104 or databases 106 may be deployed. Furthermore, for ease of illustration, various additional elements of core network 102 are omitted from FIG. 1.

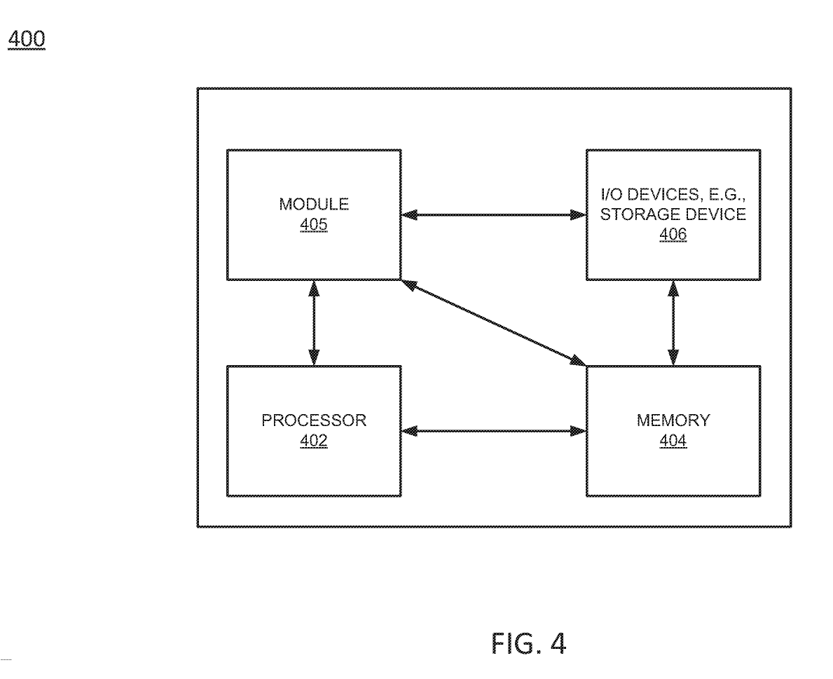

In one embodiment, the AS 104 may comprise a general purpose computer as illustrated in FIG. 4 and discussed below. In one embodiment, the AS 104 may perform the methods discussed below related to providing stimuli to regulate eating habits.

In one embodiment, the DB 106 may store data relating to nutrition and/or to user eating preferences. For example, the DB 106 may store user profiles, which users can update dynamically at any time in order to indicate nutritional goals or preferences (e.g., avoid sugar, keep daily calorie consumption below x calories, etc.). These nutritional goals or preferences could also be stored in the form of a personalized nutritional plan (e.g., foods recommended for the user by a doctor or nutritionist). The user profiles may also include relevant user history information (e.g., historical eating habits, history of stimuli sent to user to regulate eating habits, measurements of weight, blood pressure, or other health-related metrics, etc.) User profiles may be stored in encrypted form to protect user privacy. Other nutrition-related data stored by the DB 106 may include general lists of recommended (e.g. “healthy”) foods, anonymized eating patterns, and/or data about specific types of diets (e.g., gluten-free, vegan, low-sodium, sports-specific diets, etc.). At least some of this nutrition-related data could originate with doctors, nutritionists, academic research, or government or private health organizations (e.g., the National Institutes of Health, the Food and Drug Administration, etc.).

The core network 102 may be in communication with one or more wireless access networks 120 and 122. Either or both of the access networks 120 and 122 may include a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, either or both of the access networks 120 and 122 may comprise an access network in accordance with any “second generation” (2G), “third generation” (3G), “fourth generation” (4G), Long Term Evolution (LTE), or any other yet to be developed future wireless/cellular network technology including “fifth generation” (5G) and further generations. The operator of core network 102 may provide a data service to subscribers via access networks 120 and 122. In one embodiment, the access networks 120 and 122 may all be different types of access networks, may all be the same type of access network, or some access networks may be the same type of access network and other may be different types of access networks. The core network 102 and the access networks 120 and 122 may be operated by different service providers, the same service provider or a combination thereof.

In one example, the access network 120 may be in communication with one or more user endpoint devices (also referred to as “endpoint devices” or “UE”) 108 and 110, while the access network 122 may be in communication with one or more user endpoint devices 112 and 114. Access networks 120 and 122 may transmit and receive communications between respective UEs 108, 110, 112, and 124 and core network 102 relating to communications with web servers, AS 104, and/or other servers via the Internet and/or other networks, and so forth.

In one embodiment, the user endpoint devices 108, 110, 112, and 114 may be any type of subscriber/customer endpoint device configured for wireless communication such as a laptop computer, a Wi-Fi device, a Personal Digital Assistant (PDA), a mobile phone, a smartphone, an email device, a computing tablet, a messaging device, a wearable “smart” device (e.g., a smart watch or fitness tracker), a portable media device (e.g., an MP3 player), a gaming console, a portable gaming device, and the like. In one example, any one or more of the user endpoint devices 108, 110, 112, and 114 may have both cellular and non-cellular access capabilities and may further have wired communication and networking capabilities. It should be noted that although only four user endpoint devices are illustrated in FIG. 1, any number of user endpoint devices may be deployed.

It should also be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, any one or more of the user endpoint devices 108, 110, 112, and 114 may host an operating system for presenting a user interface that may be used to send data to the AS 104 (e.g., updates to user profiles/preferences, sensor readings, etc.) and for reviewing data sent by the AS 104 (e.g., alerts, recommendations, etc.).

Those skilled in the art will realize that the network 100 has been simplified. For example, the network 100 may include other network elements (not shown) such as border elements, routers, switches, policy servers, security devices, a content distribution network (CDN) and the like. The network 100 may also be expanded by including additional endpoint devices, access networks, network elements, application servers, etc. without altering the scope of the present disclosure.

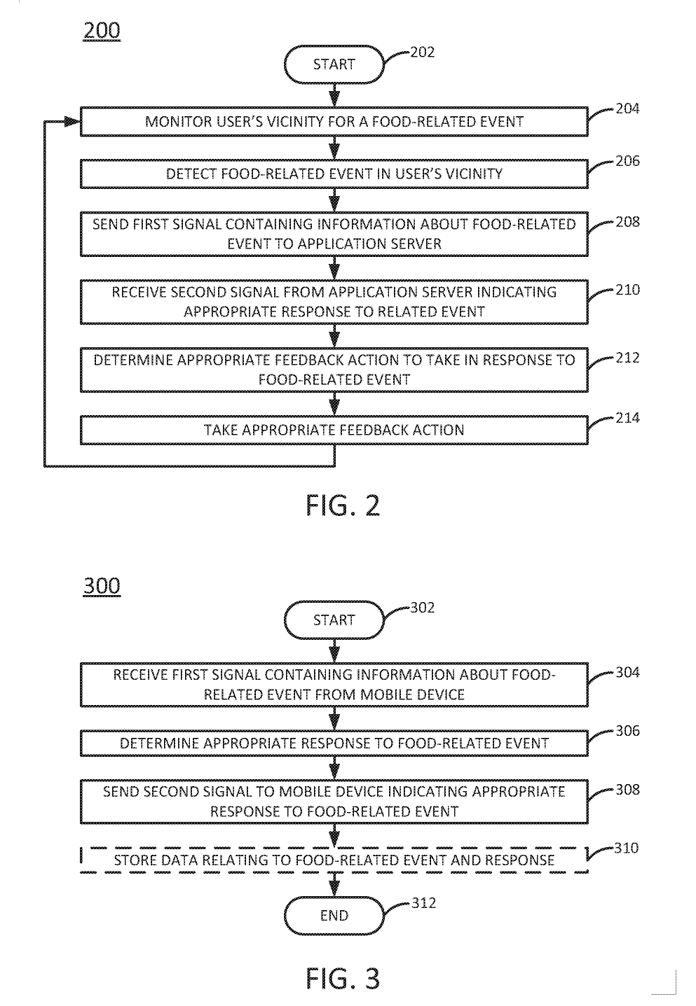

To further aid in understanding the present disclosure, FIG. 2 illustrates a flowchart of a first example method 200 for regulating a user's eating habits. In one example, the method 200 may be performed by a mobile device such as a wearable smart device, e.g., one of the user endpoint devices 108, 110, 112, or 114 illustrated in FIG. 1. However, in other examples, the method 200 may be performed by another device. As such, any references in the discussion of the method 200 to the user endpoint devices 108, 110, 112, and 114 of FIG. 1 are not intended to limit the means by which the method 200 may be performed.

The method 200 begins in step 202. In step 204, the mobile device uses one or more sensors to monitor the user's vicinity (i.e., within the range of detection of any sensors in communication with the mobile device) for a food-related event. In one example, the sensors may include image sensors (e.g., cameras), audio sensors (e.g., transducers or microphones), health monitors (e.g., glucose monitors, heart rate monitors, blood pressure monitors, or blood alcohol monitors) and other types of sensors. At least some of the sensors may be integrated into the mobile device. However, some of the sensors may also be distributed around a location (e.g., the user's home) and may communicate (e.g., wirelessly) with the mobile device.

In step 206, the mobile device detects a food-related event in the user's vicinity. For instance, a camera may detect an image of food or of a menu (e.g., in a grocery store, a restaurant, an office, or a home), or a microphone or transducer may detect an utterance related to food (e.g., a waiter asking for a meal order, a friend inviting the user to lunch, a television commercial, etc.). In one example, a recognition process (e.g., character recognition, object recognition, text recognition, or speech recognition) is employed to extract meaning from the data that is detected by the sensors (e.g., to determine that the event is food-related).

In optional step 208, (illustrated in phantom) the mobile device sends a first signal containing information about the food-related event to an application server (e.g., AS 104). For instance, the mobile device may send data (e.g., an image or an audio file) captured by one of the sensors. Alternatively, if the mobile device has identified one or more food items connected to the food-related event, the first signal may simply contain an identification of the food items.

In optional step 210 (illustrated in phantom), the mobile device receives a second signal from the application server, in response to the first signal. The second signal may indicate an appropriate response to the food-related event. For instance, if the first signal contained an image of a food item that the user is supposed to avoid (e.g., a peanut butter cookie when the user has an allergy to peanuts), the second signal may indicate that the user should be discouraged from consuming the food item. Alternatively, if the first signal contained an image of a food item that the user is permitted to eat or should be encouraged to eat (e.g., a piece of fruit where the user has high cholesterol), the second signal may indicate that the user should be encouraged to consume the food item. In one example, the user's stored profile and/or stored nutritional data (e.g., stored in the DB 106) may be consulted to determine what food items the user should be discouraged from eating or encouraged to eat.

In step 212, the mobile device determines an appropriate feedback action to take in response to the food-related event. For instance, the appropriate feedback action may be an action that encourages or discourages the user from consuming a food item that has been detected in the user's vicinity, as discussed above. In one example, the mobile device determines the appropriate feedback action independently, e.g., via execution of a local application on the mobile device that has knowledge of the user's nutritional goals or preferences. In another example, the mobile device determines the appropriate feedback action based at least in part on data from a remote source (e.g., the second signal from the application server, discussed above).

The level of specificity and the delivery mode of the appropriate feedback action may vary. For instance, in one example, the appropriate feedback action is a visible and/or audible alert. For instance, the mobile device may beep or flash a strobe to get the user's attention. Alternatively, the mobile device may generate a text message, audio message, or application-based message explicitly encouraging or discouraging consumption of a specific food item (e.g., “Don't eat the doughnut” or “You should consume at least one more serving of vegetables today”). In further examples, the appropriate feedback action may be tactile in nature. For instance, the mobile device could vibrate or create some other sort of tactile sensation (e.g., a pinching sensation, a slight increase or decrease in temperature, etc.). In yet another example, the appropriate feedback action may comprise some type of non-invasive stimulus to the user's brain using a neuro transmitter, such as a transcranial magnetic stimulation (TMS) signal using a magnetic field generator or a transcranial direct current stimulation (TDCS) signal using an electrode. Such non-invasive brain stimuli could be used to induce a specific mood of the user, where the mood is conducive to the user making appropriate food choices (e.g., the mood could be a feeling of satiety, mild repugnance, etc.).

In step 214, the mobile device takes or initiates the appropriate feedback action determined in step 212. For instance, the mobile device may beep, flash a strobe, generate a message, generate tactile feedback, or generate a non-invasive signal to stimulate the user's brain, as discussed above. The feedback action is intended to evoke a user reaction to the food-related event that is consistent with the user's nutritional goals or preferences.

The method 200 then returns to step 204 and continues to monitor the user's vicinity for food-related events.

FIG. 3 illustrates a flowchart of a second example method 300 for regulating a user's eating habits. In one example, the method 300 may be performed by an application server in communication with a mobile device, such as the AS 104 illustrated in FIG. 1. However, in other examples, the method 300 may be performed by another device. As such, any references in the discussion of the method 300 to the AS 104 of FIG. 1 are not intended to limit the means by which the method 300 may be performed.

The method 300 begins in step 302. In step 304, the application server (e.g., AS 104) receives a first signal from a mobile device, such as a wearable smart device (e.g., one of the user endpoint devices 108, 110, 112, and 114). In one example, the first signal contains information about a food-related event that was detected by the mobile device (e.g., by one or more sensors of the mobile device). For instance, the mobile device may send data (e.g., an image or an audio file) captured by one of the sensors. As an example, a camera of the mobile device may capture an image of food or an image of a menu (e.g., in a grocery store, a restaurant, an office, or a home), or a microphone or transducer of the mobile device may detect an utterance related to food (e.g., a waiter asking for a meal order, a friend inviting the user to lunch, a television commercial, etc.). Alternatively, if the mobile device has identified one or more food items connected to the food-related event, the first signal may simply contain an identification of the food items.

In step 306, the application server determines an appropriate response to the food-related event indicated in the first signal. For instance, if the first signal contained an image of a food item that the user is supposed to avoid (e.g., a peanut butter cookie when the user has an allergy to peanuts), the application server may determine that the user should be discouraged from consuming the food item. Alternatively, if the first signal contained an image of a food item that the user is permitted to eat or should be encouraged to eat (e.g., a piece of fruit where the user has high cholesterol), the application server may determine that the user should be encouraged to consume the food item. In one example, the user's stored profile and/or stored nutritional data (e.g., stored in the DB 106) may be consulted to determine what food items the user should be discouraged from eating or encouraged to eat.

In step 308, the application server sends a second signal to the mobile device, in response to the first signal. The second signal may indicate the appropriate response to the food-related event that was determined in step 306. For instance, the second signal may indicate that the user should be discouraged from consuming a food item that was depicted in an image sent by the mobile device. In one example, the second signal may also indicate a feedback action to taken by the mobile device, based on the appropriate response. For instance, the feedback action may be an action that encourages or discourages the user from consuming a food item indicated by the food-related event, such as an audible, visible, tactile, and/or non-invasive brain stimulation feedback.

In optional step 310 (illustrated in phantom), the application server stores data relating to the food-related event and the appropriate response, e.g., in a database such as the DB 106 of FIG. 1. For instance, the data may be stored in a profile associated with the user. This allows the application server to build a history for the user, which may be helpful in analyzing future food-related events and determining appropriate responses to those future food-related events. The data can also be aggregated and/or anonymized for research/academic purposes.

The method 300 ends in step 312.

Although not expressly specified above, one or more steps of the method 200 or the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or the method 300 may be implemented as the system 400. For instance, a mobile device (such as might be used to perform the method 200) or an application server (such as might be used to perform the method 300) could be implemented as illustrated in FIG. 4.

As depicted in FIG. 4, the system 400 comprises a hardware processor element 402, a memory 404, a module 405 for regulating eating habits, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for regulating eating habits may include circuitry and/or logic for performing special purpose functions relating to the monitoring, reporting, and providing feedback relating to a user's eating habits. The input/output devices 406 may include, for example, a camera, a video camera, storage devices (including but not limited to, a tape drive, a floppy drive, a hard disk drive or a compact disk drive), a receiver, a transmitter, a speaker, a microphone, a transducer, a display, a speech synthesizer, a haptic device, a neurotransmitter, a magnetic field generator, an electrode, an output port, and a user input device (such as a keyboard, a keypad, a mouse, and the like), a health-related sensor (e.g., a glucose monitor, a heart rate monitor, a blood pressure monitor, or a blood alcohol monitor), or another type of sensor.

Although only one processor element is shown, it should be noted that the general-purpose computer may employ a plurality of processor elements. Furthermore, although only one general-purpose computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for regulating eating habits (e.g., a software program comprising computer-executable instructions) can be loaded into memory 404 and executed by hardware processor element 402 to implement the steps, functions or operations as discussed above in connection with the example method 200 or the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for regulating eating habits (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method, comprising:
detecting a food-related event in a vicinity of a user;
determining a response to the food-related event in accordance with a preference of the user; and
initiating a feedback action to evoke a user reaction to the food-related event that is consistent with the response.

2. The method of claim 1, wherein the determining comprises:
sending a first signal to a remote application server, wherein the first signal contains information about the food-related event; and
receiving a second signal from the remote application server in response to the first signal, wherein the second signal indicates the response to the food-related event.

3. The method of claim 2, wherein the remote application server is in communication with a database that stores the preference.

4. The method of claim 1, wherein the method is performed by a mobile device of the user.

5. The method of claim 4, wherein the detecting is performed using a sensor in communication with the mobile device.

6. The method of claim 4, wherein the feedback action comprises an audible alert played by the mobile device.

7. The method of claim 4, wherein the feedback action comprises a visible alert displayed by the mobile device.

8. The method of claim 4, wherein the feedback action comprises a tactile alert initiated by the mobile device.

9. The method of claim 4, wherein the mobile device is a wearable smart device.

10. The method of claim 9, wherein the feedback action comprises a non-invasive brain stimulus.

11. The method of claim 10, wherein the feedback action is a transcranial magnetic stimulus initiated using a magnetic field generator.

12. The method of claim 10, wherein the feedback action is a transcranial direct current stimulus initiated using an electrode.

13. A device, comprising:
a processor; and
a computer-readable medium storing instructions which, when executed by the processor, cause the processor to perform operations comprising:
detecting a food-related event in a vicinity of a user;
determining a response to the food-related event in accordance with a preference of the user; and
initiating a feedback action to evoke a user reaction to the food-related event that is consistent with the response.

14. The device of claim 13, wherein the determining comprises:
sending a first signal to a remote application server, wherein the first signal contains information about the food-related event; and
receiving a second signal from the remote application server in response to the first signal, wherein the second signal indicates the response to the food-related event.

15. The device of claim 13, wherein the device is a mobile device of the user.

16. The device of claim 13, wherein the device is a wearable smart device.

17. An apparatus, comprising:
a sensor to detect a food-related event in a vicinity of a user;
a processor to determine a response to the food-related event in accordance with a preference of the user; and
an output device to initiate a feedback action to evoke a user reaction to the food-related event that is consistent with the response.

18. The apparatus of claim 17, wherein the apparatus is a wearable smart device.

19. The apparatus of claim 18, wherein the output device is a magnetic field generator to generate a transcranial magnetic stimulus.

20. The apparatus of claim 18, wherein the output device is an electrode to generate a transcranial direct current stimulus.
